(19) United States
(12) Patent Application Publication
(10) Pub. No.: US 2013/0074516 A1
(43) Pub. Date: Mar. 28, 2013

(54) GAS TURBINES

(71) Applicants: Philiip Graham Heward, Overton (GB); Christopher George Bladon, Shropshire (GB); Paul Desmond Barrett, Ballasalla (GB)

(72) Inventors: Philiip Graham Heward, Overton (GB); Christopher George Bladon, Shropshire (GB); Paul Desmond Barrett, Ballasalla (GB)

(73) Assignee: BLADON JETS HOLDINGS LIMITED, Douglas, Isle of Man (GB)

(21) Appl. No.: 13/637,969

(22) PCT Filed: Mar. 30, 2011
(86) PCT No.: PCT/GB11/50655

§ 371 Date: Dec. 7, 2012

(30) Foreign Application Priority Data
Mar. 31, 2010 (GB) 1005416.1

(51) Int. Cl. F02C 7/36

(52) U.S. Cl. CPC F02C 7/36
USPC 60/786

(57) ABSTRACT

A gas turbine engine arrangement comprising a first engine section (2), the first engine section (2) comprising a first compressor (4) and a first turbine (6) mounted on a first shaft (8), the gas turbine engine arrangement further comprising at least one further turbine (20) mounted on a second shaft (22) and arranged such that gases exiting the first engine section (2) are ducted to the further turbine (20), wherein said first and second shafts (8, 22) are not mechanically coupled to one another and have respective axes which are offset from each other.

This invention relates to various gas turbine arrangements, particularly although not exclusively, micro gas turbine engines used to drive a generator for generating electrical energy.

The idea of using a gas turbine engine to drive an electrical generator is well established in the art. There are several advantages to such an arrangement. Gas turbine generators provide a relatively efficient way to generate electricity, are very reliable in operation and are capable of being run on multiple fuels. Also, the “waste” heat from a gas turbine is all contained in the exhaust—there being no cooling system required as on a conventional reciprocating engine. By using this waste heat either directly for air or water heating, or to power a secondary, lower temperature heat engine—such as a steam turbine—and generator, the overall efficiency of the system can be enhanced.

It is well known that the efficiency of a gas turbine engine is directly related to the pressure ratio of its compressor. A common way to achieve high pressure ratios in gas turbines is to divide the compressor into two or three separate stages of differing sizes and rotational speeds in order to optimise performance of each stage according to its position in the engine. For example, in a three stage compressor, the first, low pressure, stage would be of a larger diameter and would run at a lower speed than the second, intermediate stage, which in turn would be larger and run more slowly than the third, high pressure, stage. In order to achieve these differential speeds, each compressor stage is mounted on its own shaft and driven by its own turbine with the three shafts running one inside the other coaxially. The Applicant has appreciated that whilst this arrangement works well for large gas turbines, it is impractical for micro gas turbines due to the difficulties of producing a coaxial bearing and lubrication system on such a small scale—typically 100 mm or less diameter—and that can withstand the very high speeds required—typically 50,000 rpm and above. The Applicant is not aware of any commercial production of a micro gas turbine engine having more than one stages.

With gas turbine generators there is a benefit of having the generator connected directly to the shaft of the engine so that the generator may be used as a motor to initiate rotation of the gas turbine engine which is required to start it. This obviates the need to provide a dedicated starter motor. Such an arrangement may also be advantageous if the generator is located upstream of the compressor of the gas turbine engine since the cool air drawn into the engine by the compressor will be drawn in past the generator, thereby obviating or reducing the need to provide separate cooling.

There are, the Applicant has appreciated, some drawbacks to the use of direct-coupled gas turbine electrical generators. One such drawback is that implementation is only really practicable on a relatively large scale since there are important constraints on the generator which can be used to convert the rotational movement into electrical energy. In particular, the generator must be of a certain size and durability to be able to handle the very high rotational speeds of a micro gas turbine engine operating efficiently. Using a gearbox to reduce the rotational speed of the generator is not desirable as it would significantly reduce efficiency due to the greater friction and would also significantly increase the amount of maintenance required and/or reduce reliability as a result of the greater number of moving parts.

Another drawback is the tendency of couplings which are required between the gas turbine engine and the generator to experience destructive vibration when driven at the very high speeds involved, which is clearly undesirable.

It is common in the large turbine art to use a so-called free turbine arrangement in which the generator is not coupled to the shaft of the gas turbine engine, but rather is provided with its own, independently rotating turbine which is driven by the hot exhaust gases from the gas turbine engine. In this configuration, the turbine of the gas turbine engine need only be sufficient to drive the compressor. Although this arrangement relaxes the requirements placed on the generator, this comes at the price of having to provide a starter motor for the gas turbine engine and cooling for the generator since the synergistic benefits of having the generator coupled to the main gas turbine shaft are lost.

When viewed from a first aspect the present invention provides a gas turbine engine arrangement comprising a first engine section, the first engine section comprising a compressor and a turbine mounted on a first shaft, the gas turbine engine arrangement further comprising at least one further turbine mounted on a second shaft and arranged such that gases exiting the first engine section are ducted to the further turbine, wherein said first and second shafts are not mechanically coupled to one another and have respective axes which are offset from each other.

Thus it will be seen by those skilled in the art that in accordance with the invention, the gas turbine engine arrangement provides a “free” turbine which is driven by exhaust gases from the first engine section, but which is not in line with the first engine section and thus this allows for a more compact arrangement. Accordingly, in a set of preferred embodiments the first and second shafts are parallel to one another.

Although the ability to make such an engine arrangement more compact may be of benefit in a large, industrial scale installation, it is of particular benefit in circumstances where much smaller engines are employed for smaller scale power generation which is one of the envisaged preferred applications of the principles of the present invention. In some sets of embodiments the gas turbine is less than 100 mm in diameter.

The further, free turbine could be used for many conceivable purposes including, but not limited to, driving machinery, operating a pump or propelling a vehicle. In a set of preferred embodiments, however, the further turbine is coupled to an electrical generator. The inventors have appreciated that this arrangement allows the engine section and the generator to be operated at their respective, but different, rotational speeds for optimum efficiency and durability. They have further appreciated that this is particularly the case where the gas turbine engine is significantly smaller than present industrial scale installations. To take one specific non-limiting example, a 10 kW micro gas turbine generator set, where the 10 kW engine section might provide optimal efficiency at 150,000 rpm but a 10 kW generator might have an optimally efficient speed of only 75,000 rpm. It may even be difficult to construct a generator which can be run reliably at 150,000 rpm. Of course, by appropriate design of the further turbine in the preferred embodiments of the invention set out above, the desired rotational speed of the generator can be obtained for a given momentum of the exhaust gases from the engine section corresponding to its maximal operating efficiency. Furthermore, the arrangement of the shafts of engine section and the generator section respectively allows for a more compact overall arrangement.

In a set of embodiments, the second shaft is coupled to a fan. Such an arrangement is particularly beneficial where a generator is also coupled to the second shaft since the fan can thus provide cooling to the generator. However, this is not essential and it is envisaged that a fan could also be beneficial where the second shaft is used to drive other machinery, with the fan providing cooling for said other machinery; or it could simply be used as a means to provide gas flow in its own right—e.g. in a wind tunnel, in a gas pipeline or in a ventilation system.

As mentioned above, a set of embodiments has a generator and a fan coupled to the second shaft so as to be driven in normal use of the apparatus by the further turbine. It is further preferred in this arrangement that a duct arrangement is provided between the fan and the engine section. This advantageously allows the fan, e.g. driven by applying electrical power to the generator, to provide a forced flow of air through the engine section which can be used to start up the engine section when it is desired to initiate operation. This therefore obviates one of the disadvantages of having a generator which is not directly coupled to the main turbine shaft of the engine—namely the lack of a self-start function—whilst retaining the benefits of decoupling which are set out hereinabove. In one set of embodiments, the above-mentioned ducting arrangement between the fan and the engine section comprises valve means arranged selectively to permit or prevent the ducting of air between them. This allows the ducting arrangement to be opened during start-up of the apparatus and thereafter to be closed for normal running of the apparatus.

In a set of preferred embodiments there is provided a further compressor coupled to the second shaft so as to be driven by the further turbine. Preferably the output of the further compressor is ducted, at least partially, to the input of the first engine section. This effectively provides a gas turbine engine with two compressor stages but with each compressor stage being driven by a respective separate, offset shaft. This enables the implementation of a two-stage gas turbine engine without the necessity of providing coaxial rotating shafts. This is particularly beneficial in implementing very small gas turbine engines since the engineering complexity involved in producing the necessary shafts, couplings and bearings etc. is significantly increased at such smaller scales. The overall engine may nonetheless still be made relatively compact by having the claimed arrangement of shafts. Such ducting also achieves the advantage of allowing self-start as with the provision of a fan.

It will be appreciated by those skilled in the art that in embodiments where such a further compressor is coupled to the second shaft and its output ducted to the input of the first engine section, a two-stage gas turbine engine is formed where the further compressor is equivalent to what would normally be called the first stage, or low pressure compressor. To avoid confusion this will be referred to herein as the low pressure compressor. The second turbine recited above will be correspondingly be referred to as the low pressure turbine. Similarly in such arrangements the compressor and turbine of the recited first engine section will be referred to respectively as the high pressure compressor and turbine.

Such arrangements as are described above are considered to be novel and inventive in their own right and thus when viewed from a second aspect the invention provides a gas turbine engine comprising: a high pressure stage including a high pressure compressor and a high pressure turbine coupled to a first shaft and a low pressure stage including a low pressure compressor and a low pressure turbine coupled to a second shaft, wherein said first and second shafts are non-coaxial.

Typically a combustor would be provided between the high pressure compressor and turbine.

Preferably a duct is provided between the high and low pressure turbines. Preferably a duct is provided between the low and high pressure compressors.

The two-stage engine described above may be used in any of the configurations in which a standard gas turbine engine is used. Thus, one possible configuration would be as a turbojet—e.g. to provide motive thrust for an aircraft or other vehicle. Alternatively, as set out in accordance with the first aspect of the invention, the second shaft (associated with the low pressure stage) could be used as a turbo shaft. Indeed, in accordance with the second aspect of the invention, the high pressure stage shaft could be used as a turbo shaft instead of, or in addition to the low pressure shaft. This will to some extent depend upon which one of the two shafts gives the most desirable rotational speed. Again, in a set of preferred embodiments the second, low pressure stage shaft is coupled to a generator for generating electricity from its rotational movement. Such a configuration is particularly preferred since, as described above, it allows the generator to be used as a starter for the engine by driving the low pressure compressor when electrical power is applied to it. Furthermore, the presence of the low pressure compressor facilitates the provision of air cooling for the generator which can be located in the air intake for the low pressure compressor.

It will be appreciated from the foregoing that at least in some aspects, the invention proposes a two-stage gas turbine engine in which the shafts connecting the compressors and turbines of the two respective stages are not coaxial, but rather have offset, preferably parallel axes. This separation of the shafts of the respective stages is accommodated by ducting of gases between the respective compressors and between the respective turbines. This principle is, however, not limited to a gas turbine engine comprising just two stages; it can be extended to an engine having any number of stages. In principle, the invention covers such an engine comprising three or more stages in which two or more of the stages comprise mutually coaxial shafts. However, it is believed that the benefit derivable from the application of the principles of the invention is maximised by having each of the respective shafts for each stage mutually offset from one another—i.e. where none of the stages is coaxial with any other.

It is well known in the art that energy in the form of heat can be recovered from the exhaust gases of a gas turbine. In some embodiments of the current invention means are provided for recovering heat from the exhaust gases—e.g. by means of a heat exchanger. The recovered heat could be used for many different purposes e.g. space heating, direct generation of electrical power or, in some embodiments, for pre-heating the compressed air supplied to the combustor associated with the first engine section. This is known in the art as recuperation.

In some embodiments, means for cooling the air between respective compressor stages is provided. As is well known in the art per se, such inter-cooling helps further to increase the efficiency of the overall engine.

Preferably a combustor section is provided as part of the high pressure engine section—i.e. between the high pressure compressor and the high pressure turbine in order to drive the high pressure turbine as is well known in the art. Further combustor sections could be provided e.g. between the high pressure and low pressure turbine stages or in the exhaust stream of a thrust engine. This is known in the art as reheat.

Where provided, the generator may be of any suitable type or any suitable rating appropriate to its intended use. In preferred embodiments where the generator is also used as a starter motor, this will typically also need to be taken into account when selecting or designing an appropriate generator. The generator could, for example, be of the permanent magnet type or it could be of the switched reluctance (“SR”) or inductance type. However, other types are not excluded.

In one set of embodiments, axial flow compressors and turbines are used. However, this is not essential and, for example, centrifugal compressors and radial turbines could be used, or indeed any combination of these and axial flow arrangements could be used to suit the particular circumstances.

Certain embodiments of the invention will now be described, by way of example only, with reference to the accompanying drawings in which:

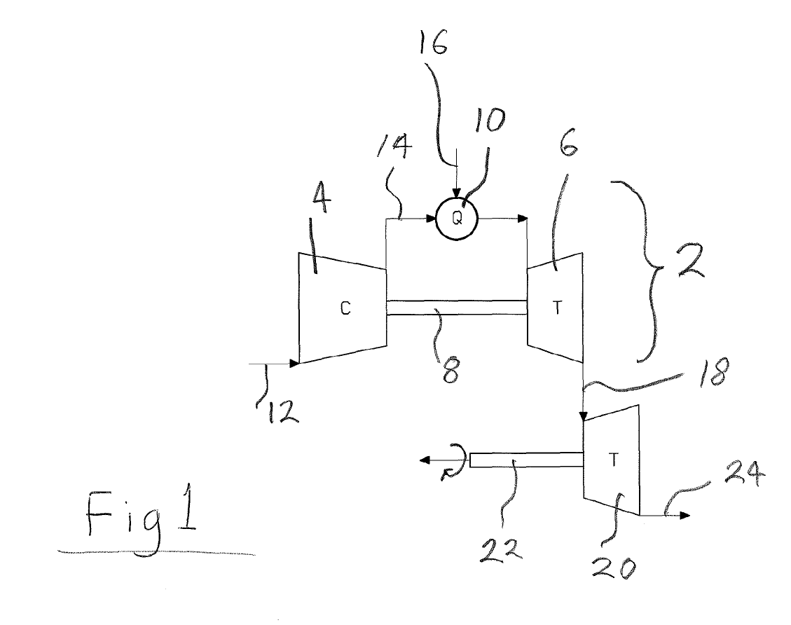

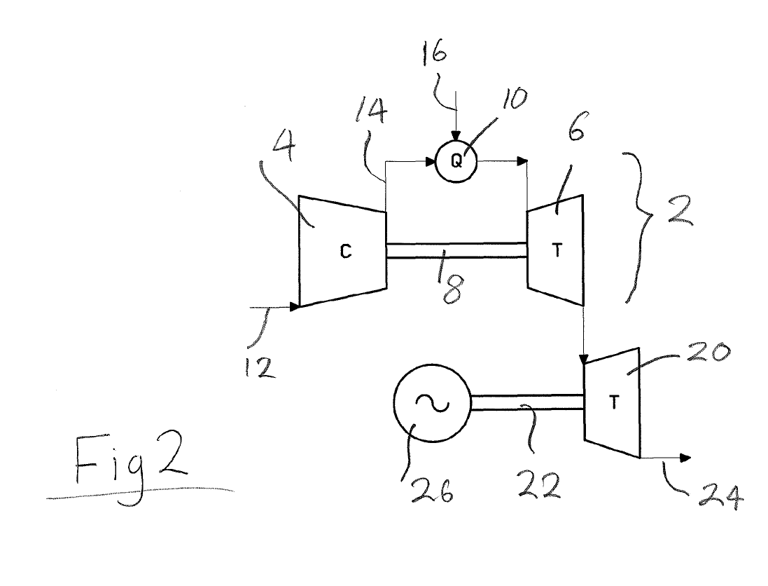

FIG. 1 is a schematic illustration of an embodiment of the invention comprising a turbo shaft and single stage compressor;

FIG. 2 is a schematic representation of an embodiment similar to FIG. 1 used as a turbo generator;

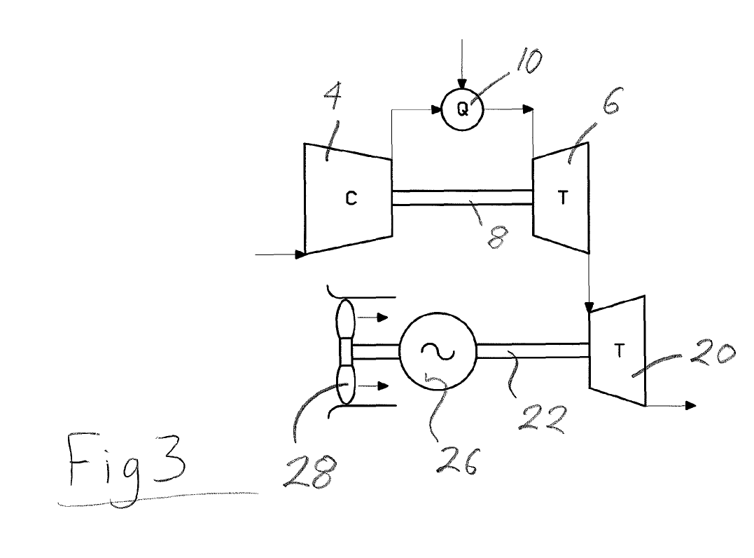

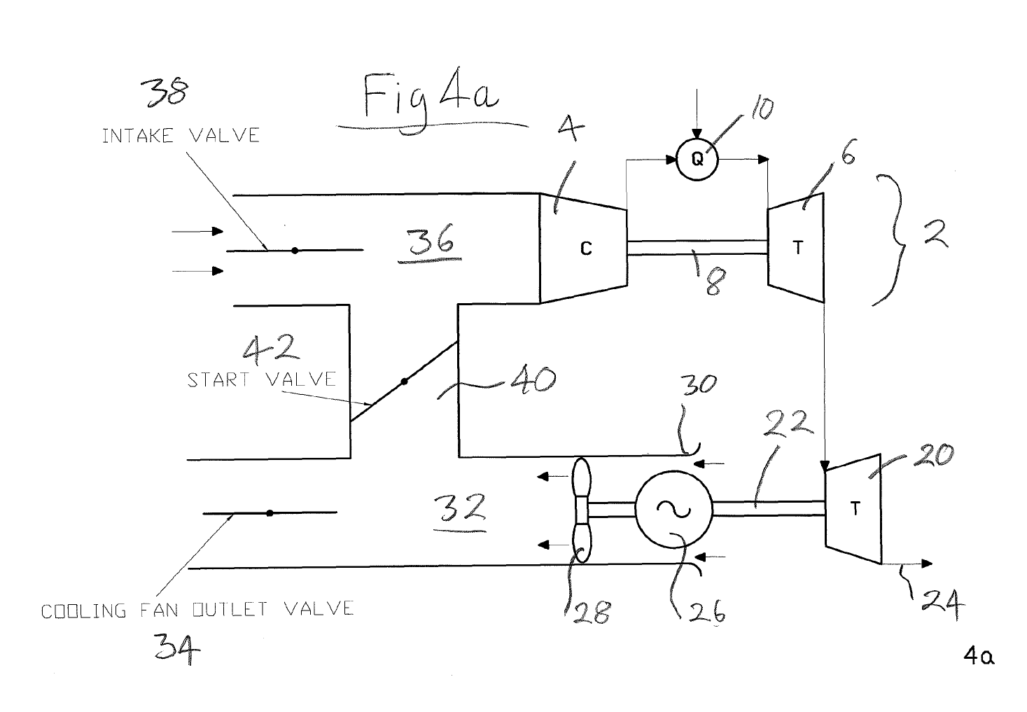

FIG. 3 is a schematic representation of an embodiment similar to that of FIG. 2 with the addition of a fan for cooling the generator;

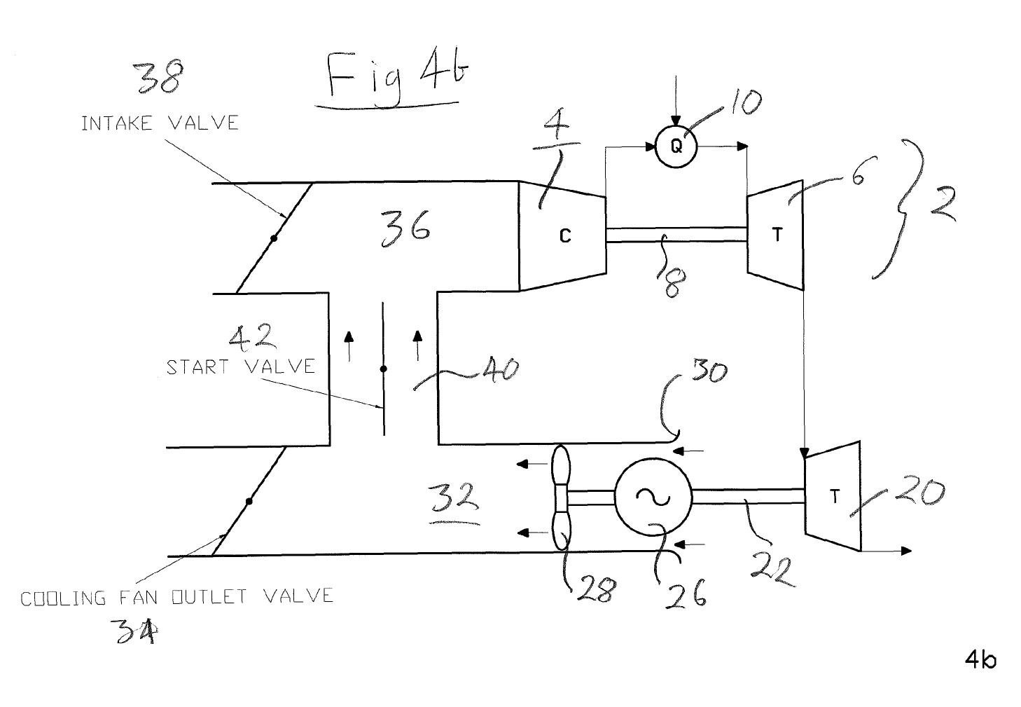

FIG. 4a is a schematic representation of an engine arrangement with an air starter shown in normal operating configuration;

FIG. 4b is a representation of the same arrangement as FIG. 4a but in the starting configuration;

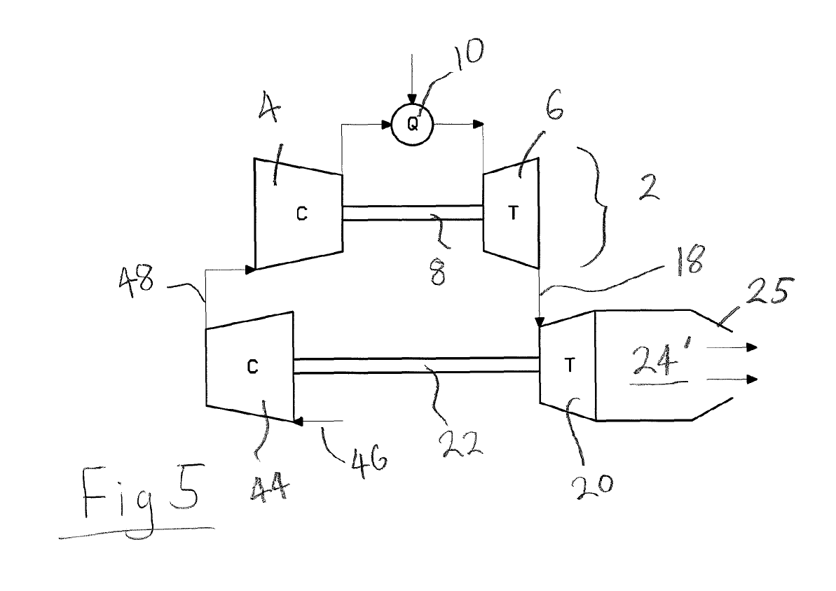

FIG. 5 is a schematic representation of a turbo jet arrangement with two stage compressor;

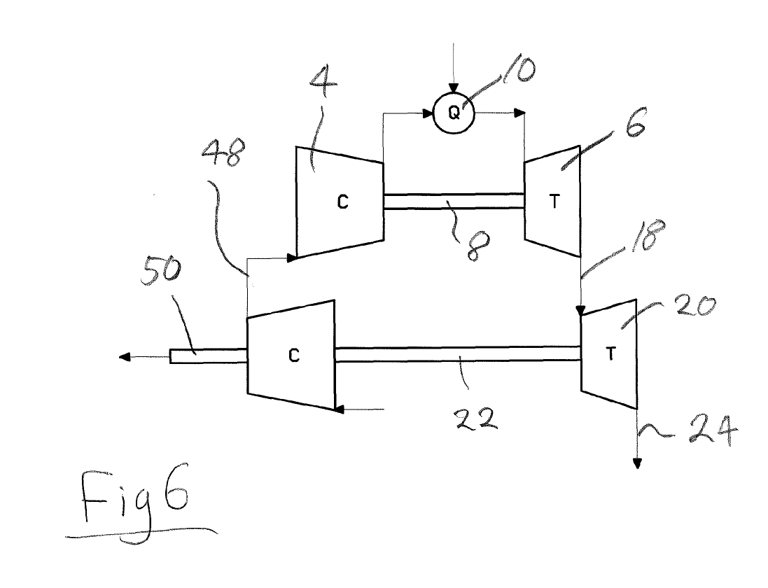

FIG. 6 is a representation of a turbo shaft arrangement with two stage compressor;

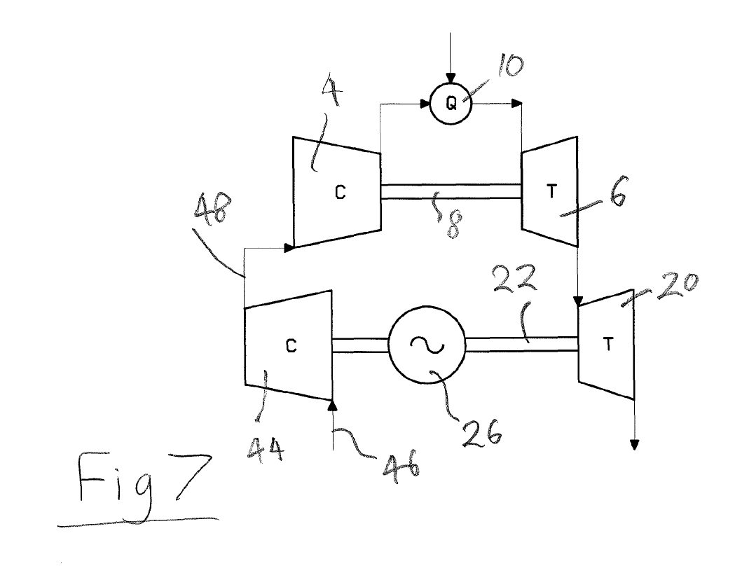

FIG. 7 shows an arrangement similar to FIG. 6 with the addition of a generator;

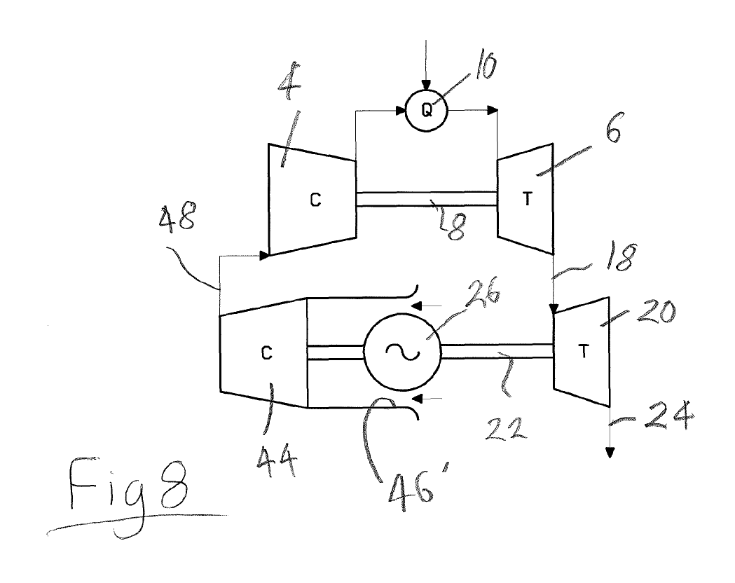

FIG. 8 shows an arrangement similar to FIG. 7 but configured to provide air cooling for the generator;

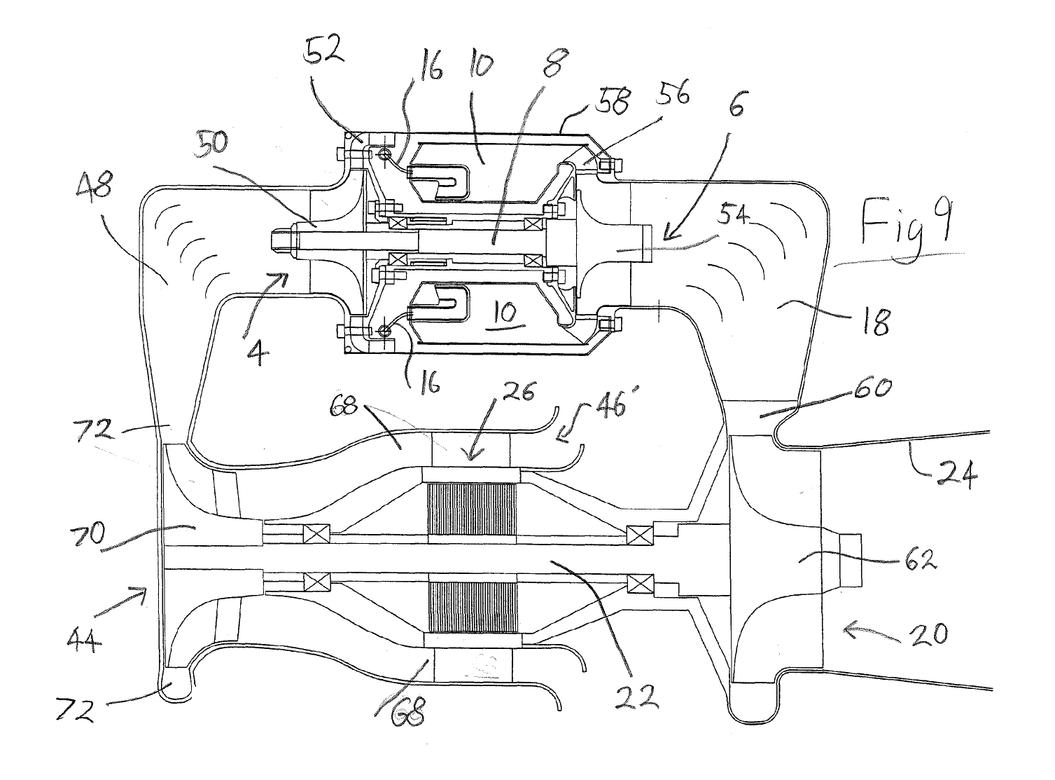

FIG. 9 shows a more detailed view of an implementation of the arrangement represented in FIG. 8;

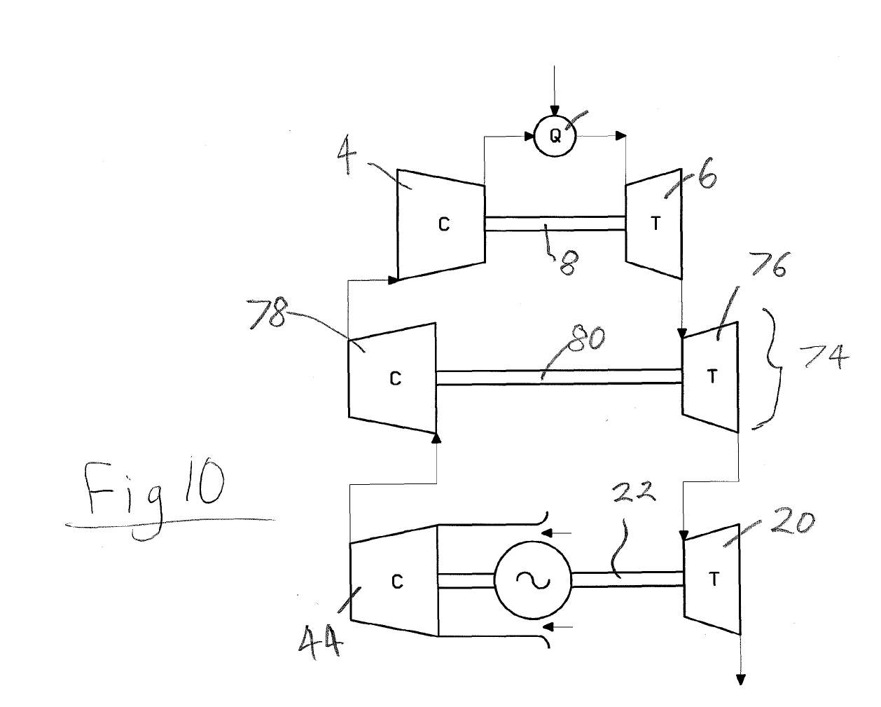

FIG. 10 shows an arrangement similar to that in FIG. 8 but with three compressor stages;

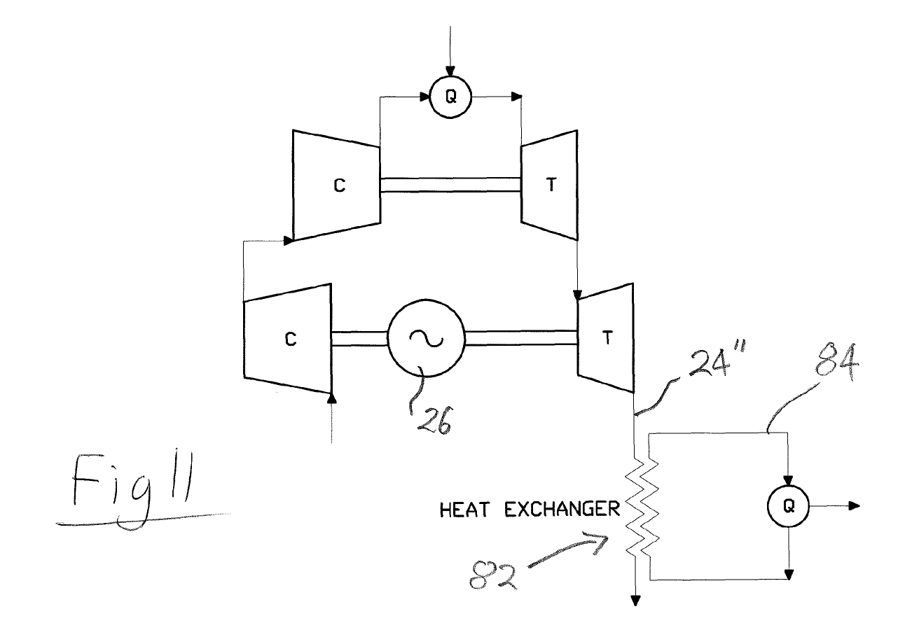

FIG. 11 shows a two-stage turbo generator arrangement with heat recovery;

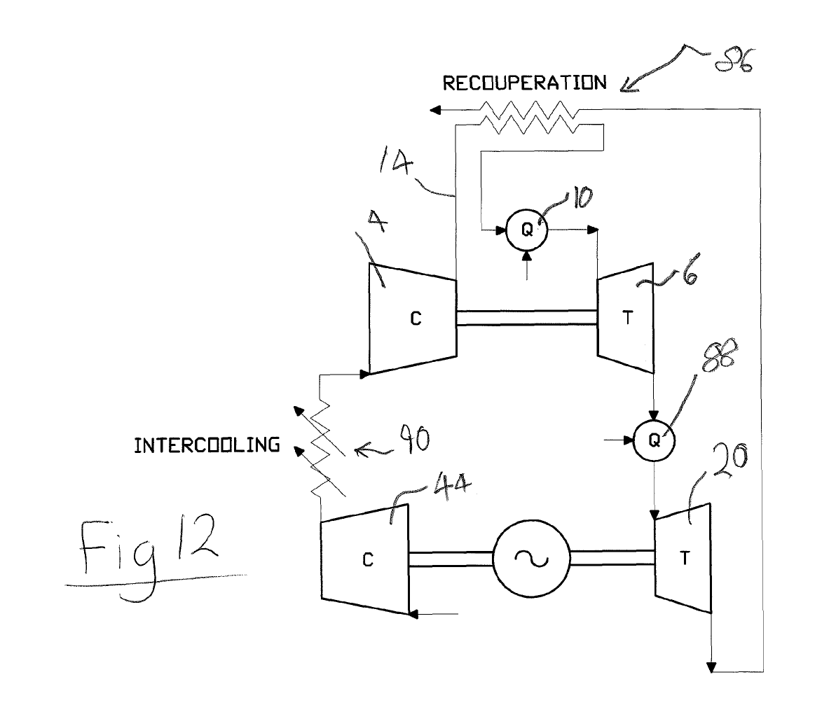

FIG. 12 shows a two-stage compressor with recuperation, intercooling and reheating; and

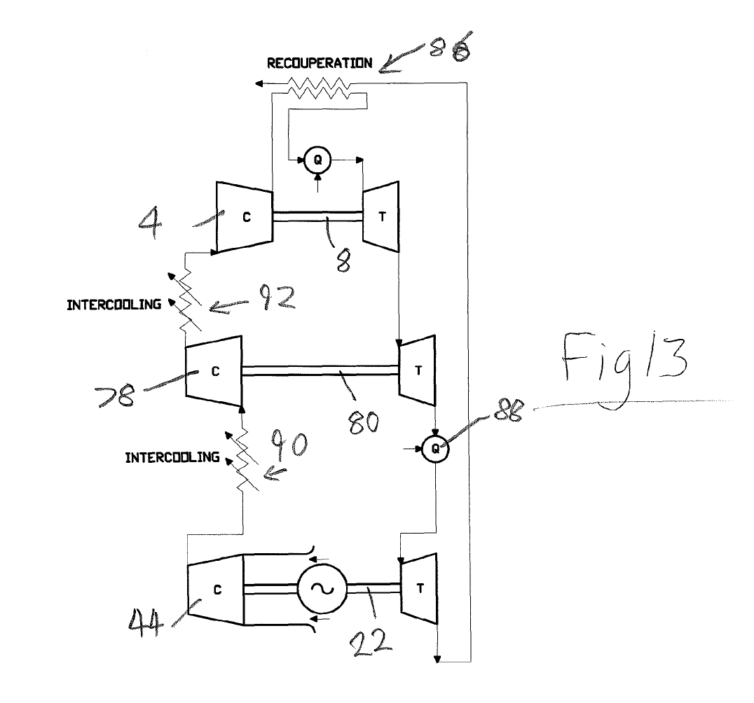

FIG. 13 shows an arrangement similar to that of FIG. 12 but with three stages.

FIG. 1 shows a highly simplified schematic representation of a very basic implementation of the principles of one aspect of the invention. The Figure shows a gas turbine engine arrangement having a first engine section 2. The first engine section 2 comprises a compressor 4 and a turbine 6 which are both mounted for rotation about a common axis on a common first shaft 8.

A combustor 10 is provided between the compressor 4 and the turbine 6. The gas turbine engine section 2 operates in conventional fashion with the compressor 4 taking in air as represented by the arrow 12 and compressing it. The compressed air passes from the compressor 4 to the combustor 10 as represented by the arrow 14. Fuel enters the combustor 10 by means of a fuel inlet 16 and is burnt in the presence of the compressed air producing a blast of hot expanded gases which drive the turbine 6. The turbine 6 rotates the shaft 8 and thereby drives the compressor 4.

In accordance with the invention, the hot gases exiting the turbine 6 are ducted, by means of a duct represented by the arrow 18 to a further turbine 20 which drives a second shaft 22. The gases, which will at this point be cooler and slower, leave the apparatus by means of an exhaust represented by the arrow 24.

It will be appreciated from the foregoing description of the embodiment represented in FIG. 1, that the two shafts 8, 22 are separate and not mechanically coupled to one another. The shafts 8, 22 are shown as being parallel, but they could equally be disposed at a mutual angle—i.e. at right angles or any angle in between. However, since the shafts are not coaxial their arrangement relative to one another can be highly flexible. Moreover, there is no need for complex and potentially unreliable concentric bearings and the like. Moreover, it may be appreciated that by appropriate choice of the relative sizes, pitches etc. of the respective rotors and blades in the two turbines 6, 20, the rotational speed of the second shaft 22 which corresponds to the optimum operating speed of the gas turbine engine section 2 can be chosen from a relatively wide range.

The shaft 22 could be used for a large number of purposes. It could, for example, be used to drive the axle of a vehicle to provide motive power, or it could be used to operate machinery. However, one particularly advantageous application of the arrangement set out in FIG. 1, is to drive the spindle of a generator in order to convert the rotational motion of the second shaft 22 to electrical energy. This is shown in FIG. 2 where it may be seen that a generator 26 is coupled to and driven by the second shaft 22. This allows the engine arrangement to produce electricity efficiently. In this application, the advantage of being able to determine the rotational speed of the second shaft 22 which is different from the corresponding rotational speed of the first shaft 8 may be particularly realised since the optimum (or maximum permissible) operating speed of the generator 26 is likely to be significantly lower and the optimum operating speed of the gas turbine engine section 2. For example, if the engine section 2 is provided by a 10 kW micro-gas turbine engine this might have an optimum efficiency at approximately 150,000 rpm. However, by designing the further turbine 20 appropriately, particularly in respect of its diameter, a rotational speed of only 75,000 rpm may be imparted to the second shaft 22 which may be a more typical optimum efficiency speed for a 10 kW generator. The arrangement shown in FIG. 2 can be particularly beneficially applied to relatively small scale engines which allow for the efficient localised micro-generation of electricity.

FIG. 3 shows an arrangement similar to that shown in FIG. 2, except that a fan 28 is also coupled to the second shaft 22 which is driven by the further turbine 20. Whilst there are many conceivable functions which could be fulfilled by a fan driven by the further turbine, in this particular example the fan 28 is used to create a flow of air over the generator 26 which provides cooling for it. This might avoid the need to provide any additional cooling and/or it may allow the generator 26 to operate at a higher power rating and/or more efficiently.

FIGS. 4a and 4b show an advantageous extension of the arrangements set out in FIG. 3. As in the previously described embodiment, a fan 28 is coupled to the second shaft 22 so as to be driven by the further turbine 20, thereby providing a cooling air flow past the generator 26 (although it will be noted that in this depiction, the air flow past the generator is in the opposite direction to that shown in FIG. 3). The air is drawn in through a cooling air intake 30, past the generator 26 and the fan 28 to an exit duct 32 downstream of the fan. The exit duct 32 may be open or closed by a valve 34 at the far end. The valve 34 is shown in its open position in FIG. 4a.

Also shown in FIGS. 4a and 4b is an air intake duct 36 into which air is drawn by the compressor 4. This too may be open or closed depending upon the position of an intake valve 38, shown in its open position in FIG. 4a. A connecting duct 40 is provided between the previously described intake duct 36 and the outlet duct 32. A further valve 42 is provided in the connecting duct 40 in order to open or close it. This valve 42 is shown in its closed position in FIG. 4a.

In operation, FIG. 4a shows the normal running state of the apparatus. Thus the gas turbine engine section 2 draws air in through the air intake duct 36 and the hot air and combustion gases are eventually exhausted through the hot gas exhaust 24 downstream of the further turbine 20. An independent gas flow path is set up by rotation of the fan 28 by the second shaft 22 which draws in air through the cooling air intake 30 before it exits again through the outlet duct 32 and past the valve 34. These two flow paths remain independent of one another since the valve 42 in the connecting duct 40 remains closed during steady state operation of the apparatus.

However, this apparatus can also be used in a self-starting mode which is represented in FIG. 4b. In this mode, the intake valve 38 and cooling fan outlet valve 34 are both closed while the valve 42 in the connecting duct 40 is opened. At the same time, the generator 26 is operated as a motor by applying a suitable electrical current to it which has the effect of rotating the shaft 22 and thereby driving the fan 28. This has the effect of drawing air in through the cooling air intake 30 (and past the motor 26, thereby cooling it) and so into the outlet duct 32. However, since the cooling fan outlet valve 34 is closed and the connecting duct valve 42 is open, the air is forced to pass through the connecting duct 40 and into the intake duct 36 for the compressor 4. Again, since the intake valve 38 is closed, the air flow is forced into the compressor 4 which in this circumstance is therefore made to act like a turbine. Accordingly the forced air flow rotates the compressor 4 and hence the first shaft 8 and the turbine 6. However simultaneously or when the shaft 8 has reached a certain speed, typically around 30% of the maximum operating speed, the combustor 10 may be switched on. This operation is continued until self-sustaining rotation of the shaft 8 of the engine section 2 is achieved. At this point, the electrical power source may be removed from the motor 26 and the three valves 34, 38, 40 operated to change their states to those shown in FIG. 4a so as to permit continuous, steady-state operation.

As will be appreciated, the arrangement described above with reference to FIGS. 4a and 4b provides a compact and self-contained arrangement for generating electricity without the need for any external starting equipment. This allows such apparatus to be used to give highly flexible power generation which can be started and stopped with relative ease.

FIG. 5 represents another way in which the basic principle illustrated in the embodiment of FIG. 1 may be developed in other embodiments. In common with the embodiment of FIG. 1, a gas turbine engine section 2 comprising a compressor 4, turbine 6, shaft 8 and combustor 10 is provided. Also as in FIG. 1, the hot gases 18 exiting the first turbine 6 are used both to drive a further turbine 20, which in turn rotates a coupled shaft 22, and to provide thrust by accelerating the hot gas exhaust 24′ through a nozzle 25. This arrangement could, as just one example, be used to provide a motive thrust, e.g. for an aircraft or other vehicle.

Where this embodiment differs from that shown in FIG. 1, is that the second shaft 22 is used to drive a further compressor 44 which is coupled to it. This further compressor 44 takes in air through an air intake 46, compresses it and delivers the compressed air through a duct 48 to the first compressor 4. It will be appreciated, therefore, that this embodiment represents a two-stage gas turbine engine: the further turbine 20 and the further compressor 44 form the low pressure stage and the first compressor 4 and first turbine 8 form the high pressure stage. As is well known in the art, this gives an overall pressure ratio equal to the product of the individual pressure ratios of the two compressors 44, 4. For example, if the low pressure compressor 44 has a pressure ratio of 5:1 and the high pressure compressor 4 has a pressure ratio of 4:1, the overall pressure ratio of the engine is 20:1. However, unlike in a conventional two-stage gas turbine engine, the two compressor stages 44, 4 are not coaxial, but rather the axes of the respective shafts 22, 8 are offset from one another (and are depicted as being parallel).

Whilst the need to pass the intermediate compressed air and the intermediate hot gases through ducts 48, 18 respectively inevitably results in a minor reduction in efficiency as compared to that which is theoretically achievable with a coaxial engine, this is, the inventors have appreciated, more than outweighed by the improved durability and manufacturability which can be achieved by avoiding the need for coaxial bearings etc. This is particularly the case where an engine is very small—e.g. with a maximum turbine diameter less than 100 millimetres. Indeed, it would be a considerable engineering challenge to produce the necessary concentric rotating shafts and associated bearings to operate at the very high rotational speeds necessary for efficient performance at such small scales.

FIG. 6 shows an embodiment similar to FIG. 5 except that instead of providing fast-moving gases to generate thrust, the low pressure turbine 20 is designed to extract as much energy as possible from the gases 18 issuing from the high pressure turbine. This allows the driveshaft 22 to provide an external rotary drive 50 as well as driving the compressor 44. As in the case of the embodiment of FIG. 1, the external drive 50 may be used for a wide variety of purposes.

FIG. 7 shows a further variant of the principle behind the embodiments of FIG. 5 and FIG. 6. In this embodiment, a generator 26 is coupled to the low pressure-stage shaft 22 in order to allow the engine to be used for generating electrical power. It should also be noted that the generator 26 provides a further advantage in that it can be used to start the engine as a whole by applying electrical power to it, thereby causing rotation of the low pressure-stage shaft 22. This in turn drives the low pressure compressor 44 which forces air to flow through the duct 48 to the high pressure compressor 4. This provides a self-start mechanism similar to that previously described with reference to FIGS. 4a and 4b except that the arrangement is even further simplified in this embodiment as there is no need to open or close any valves between starting and ordinary running of the engine.

FIG. 8 represents a variant of the embodiment in FIG. 7 whereby the air intake 46′ for the high pressure compressor 44 is configured so as to draw air past the generator 26 thereby providing cooling for it. The arrangement of FIG. 8 is presently considered to be particularly advantageous and a more detailed implementation of such an arrangement is shown in FIG. 9.

Turning to FIG. 9, the main parts of the engine shown in FIG. 8 are shown in FIG. 9 with the same reference numerals, although more details may be seen. Starting with the high pressure compressor 4, this comprises a rotor 50 coupled to the rotary shaft 8 and a diffuser 52 mounted on the generally cylindrical housing engine casing 58. At the other end of the shaft 8 is the high pressure turbine 6 comprising a nozzle ring 56 mounted on the engine casing and a rotor 54 mounted to the shaft. The high pressure compressor 4 and turbine 6 are both depicted in FIG. 9 to be of a radial flow type, but could equally well be of axial flow type or there could be a mix of both types.

Between the high pressure compressor 4 and turbine 6 can be seen the combustor section 10 with the fuel inlets 16. An angled duct 18 is connected to the downstream end of the engine casing 58 in order to channel the hot exhaust gases from the engine onto the low pressure turbine 20. The duct 18 is shaped to direct the gases through a 90° turn.

The low pressure turbine 20 is preferably also of a radial flow type since it is driven by the gases exiting the duct 18 impinging through the nozzle ring 60 onto the blades of the rotor 62 at right angles to its direction of rotation. The rotor 62 is attached to the second shaft 22 in order to turn it. After having traversed the rotor 62, the gases are exhausted out through the hot exhaust 24.

Midway along the second shaft 22 is mounted the rotor 64 of the generator 26 which can also be operated as a motor. The motor/generator, or electrical machine, depicted is of a generic type. Many types of electrical machine are possible including permanent magnet, induction or switched reluctance types and, as is well known in the art, most types can be designed to operate as both motor and generator.

A further air intake 46′ draws air in through an annular channel 68 around the periphery of the generator 26 in order to provide cooling for it. The air is drawn in by the low pressure compressor 44 at the other end of the second shaft 22. The shaft 22 rotates the rotor 70 of the low pressure compressor. In this example the low pressure compressor 44 is of a radial flow type so that the blades of the rotor 70 are configured to draw air in generally axially, but to eject the compressed air radially through the diffuser 72 into the duct 48 which connects to the upstream end of the engine section casing 58. However use of a radial flow compressor is not essential.

The apparatus shown in FIG. 9 operates in the same manner as that described with reference to FIG. 8 and thus it can be used in normal running mode to generate electrical power from the generator 26 using a highly efficient two-stage compressor gas turbine engine arrangement which realises the previously discussed advantages of having two separate, offset shafts 8, 22. Moreover, the generator 26 can be used as a motor to start the engine as a whole.

FIG. 10 is another schematic representation of a possible embodiment of the invention. This is somewhat similar to the embodiments shown in FIG. 8, except that there is an intermediate compressor stage 74 comprising an additional turbine 76 and an additional compressor 78 mounted on a third shaft 80. As will be appreciated, this intermediate stage further increases the pressure ratio available, but following the principles described above, the shaft 80 connecting its turbine 76 and compressor 78 is separate and offset from the shafts 8, 22 of the other stages of the engine. Otherwise, this arrangement works in the same way as has been described above in relation to FIGS. 8 and 9.

FIG. 11 shows an arrangement similar to that shown in FIG. 7 except that the hot exhaust 24″ is directed to one side of a heat exchanger 82, the other side of which is represented as a generalised heating circuit 84 which might take many physical forms. It will be appreciated therefore that the embodiment represented in this figure can be operated as a combined heat and power (CHP) plant whereby the fuel can be used to provide electrical energy by means of the generator 26 but can also provide e.g. hot water for supplying domestic, commercial or industrial premises.

FIG. 12 indicates schematically an arrangement conceptually similar to that shown in FIG. 11, but where the heat exchanger 86 is used for internal heat recuperation by preheating the compressed air 14 exiting the high pressure compressor 4 before it enters the combustor 10. This allows for an increase in efficiency of the engine. Also illustrated in this Figure is a second combustor section 88 between the high and low pressure turbines 6, 20. Again, under certain circumstances this can raise capacity and/or efficiency. A further feature of the arrangement shown in FIG. 12 is an intercooler 90 provided between the low and high pressure compressors 44, 4, again to increase efficiency or production capacity as is known per se in the art. It should be appreciated that the features illustrated in this embodiment such as the recuperation unit 86, additional combustor 88 and intercooler 90 may be employed in any other embodiment, including those previously described herein.

Finally, FIG. 13 illustrates a combination of the principles illustrated in the embodiments of FIG. 10 and FIG. 12-namely to provide an engine arrangement with three compressor stages plus a recuperation unit 86, additional combustor 88 and respective intercoolers 90, 92 between the respective compressors 44, 78, 4. As with the embodiment of FIG. 10, three stages are illustrated but in principle any number of stages could be provided. Moreover, although the stages are all shown as having mutually parallel and offset shafts 8, 22, 80 this is not essential and two or more of them could have coaxial shafts.

It will be seen form the foregoing that in at least some of its embodiments this invention enables the construction of multi-stage micro gas turbines without the necessity for coaxial shafts. It also enables starting of a gas turbine by a free turbine coupled generator and provides air cooling for a free turbine coupled generator, all within a more compact design.

It will be appreciated by those skilled in the art that certain specific embodiments of the principles of the invention have been described above but these are intended merely to be examples of how those principles may be applied and there are many different modifications and variations which may be made within the scope of the invention. The description as given above should not therefore be considered limiting but merely illustrative. The features of any of the embodiments shown may be in general applied to any other embodiment and the disclosure of two features in one embodiment should not be considered as an indication that those features are necessarily to be provided together.

1.-42. (canceled)

43. A gas turbine engine arrangement comprising a first engine section, the first engine section comprising a first compressor and a first turbine mounted on a first shaft, the gas turbine engine arrangement further comprising at least one further turbine mounted on a second shaft and arranged such that gases exiting the first engine section are ducted to the at least one further turbine, wherein said first and second shafts are not mechanically coupled to one another and have respective axes which are offset from each other, wherein the further turbine is coupled to an electrical generator, and wherein the electrical generator is arranged to start the first engine section.

44. The gas turbine engine arrangement of claim 43 wherein the first and second shafts are parallel to one another.

45. The gas turbine engine arrangement of claim 43 wherein the first turbine and the at least one further turbine are each less than 100 mm in diameter.

46. The gas turbine engine arrangement of claim 43 wherein the second shaft is coupled to a fan.

47. The gas turbine engine arrangement of claim 46 wherein a duct arrangement is provided between the fan and the first engine section.

48. The gas turbine engine arrangement of claim 47 wherein the duct arrangement between the fan and the first engine section comprises a valve arrangement arranged selectively to permit or prevent ducting of air between said fan and said first engine section during use of the gas turbine engine arrangement.

49. The gas turbine engine arrangement of claim 46 wherein the fan is arranged to start the first engine section.

50. The gas turbine engine arrangement of claim 43 further comprising a further compressor coupled to the second shaft, wherein the further compressor is driven by the at least one further turbine.

51. The gas turbine engine arrangement of claim 50 wherein at least a portion of an output of the further compressor is ducted to an input of the first engine section.

52. The gas turbine engine arrangement of claim 50 wherein the further compressor is arranged to start the first engine section.

53. The gas turbine engine arrangement of claim 53 wherein the first engine section further comprises a combustor section between the first compressor and the first turbine.

54. The gas turbine engine arrangement of claim 53 further comprising at least one further combustor section.

55. The gas turbine engine arrangement of claim 54 wherein the at least one further combustor section is disposed between the first turbine and the at least one further turbine.

56. The gas turbine engine arrangement of claim 54 wherein the at least one further combustor section is disposed in an exhaust stream of the gas turbine engine arrangement.

57. The gas turbine engine arrangement of claim 43 further comprising an arrangement for recovering heat from exhaust gases produced by the gas turbine engine arrangement during use.

58. The gas turbine engine arrangement of claim 57 wherein the heat recovered by the arrangement for recovering heat from the exhaust gases is used for pre-heating compressed air supplied to a combustor section.

59. The gas turbine engine arrangement of claim 50 further comprising an arrangement for cooling air between the further compressor and the first compressor.

60. The gas turbine engine arrangement of claim 43 wherein the first compressor is an axial flow compressor, and wherein the first turbine and the at least one further turbine are axial flow turbines.

61. The gas turbine engine arrangement of claim 43, further comprising at least one further shaft, and at least one of (i) an additional turbine and (ii) an additional compressor coupled to the at least one further shaft, wherein the at least one further shaft is non-coaxial with the first and second shafts.

62. A gas turbine engine comprising: a high pressure stage including a high pressure compressor and a high pressure turbine coupled to a first shaft, and a low pressure stage including a low pressure compressor and a low pressure turbine coupled to a second shaft, wherein said first and second shafts are non-coaxial, wherein the second shaft is coupled to a generator, and wherein the generator is arranged to start the gas turbine engine.

63. The gas turbine engine of claim 62 wherein a combustor section is provided between the high pressure compressor and the high pressure turbine.

64. The gas turbine engine of claim 63 further comprising at least one further combustor section.

65. The gas turbine engine of claim 64 wherein the at least one further combustor section is disposed between the high pressure turbine and the low pressure turbine.

66. The gas turbine engine of claim 64 wherein the at least one further combustor section is disposed in an exhaust stream of the gas turbine engine.

67. The gas turbine engine of claim 62 wherein a duct is provided between the high pressure turbine and the low pressure turbine.

68. The gas turbine engine of claim 62 wherein a duct is provided between the low pressure compressor and the high pressure compressor.

69. The gas turbine engine of claim 62 wherein the further compressor is arranged to start the gas turbine engine.

70. The gas turbine engine of claim 62 wherein the second shaft is coupled to a fan.

71. The gas turbine engine of claim 70 wherein a duct arrangement is provided between the fan and the high pressure stage.

72. The gas turbine engine of claim 71 wherein the duct arrangement between the fan and the high pressure stage comprises a valve arrangement arranged selectively to permit or prevent ducting of air between said fan and said high pressure stage during use of the gas turbine engine.

73. The gas turbine engine of claim 70 wherein the fan is arranged to start the gas turbine engine.

74. The gas turbine engine of claim 62 wherein the first and second shafts have parallel axes.

75. The gas turbine engine of claim 62 further comprising an arrangement for recovering heat from exhaust gases produced by the gas turbine engine during use.

76. The gas turbine engine of claim 75 wherein the heat recovered by the arrangement for recovering heat from the exhaust gases is used for pre-heating compressed air supplied to a combustor section.

77. The gas turbine engine of claim 62 further comprising an arrangement for cooling air between the low pressure compressor and the high pressure compressor.

78. The gas turbine engine of claim 62 wherein the high pressure and low pressure compressors are axial flow compressors, and wherein the high pressure and low pressure turbines are axial flow turbines.

79. The gas turbine engine of claim 62 wherein the high pressure and low pressure turbines are each less than 100 mm in diameter.

80. The gas turbine engine of claim 62, further comprising at least one further stage, wherein the at least one further stage comprises a further turbine and a further compressor coupled to a further shaft, wherein the further shaft is non-coaxial with the first and second shafts.
